(19) United States
(12) Patent Application Publication
(10) Pub. No.: US 2009/0047206 A1
(43) Pub. Date: Feb. 19, 2009

(54) CATALYST PARTICLE FOR PRODUCTION OF CARBON NANOCOIL, PROCESS FOR PRODUCING THE SAME, AND PROCESS FOR PRODUCING CARBON NANOCOIL

(76) Inventors: Nobuharu Okazaki, Okayama (JP); Yugo Higashi, Kyoto (JP); Yoshikazu Nakayama, Osaka (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/293,311

(22) PCT Filed: Mar. 20, 2007
(86) PCT No.: PCT/JP2007/055596

§ 371 Date: Sep. 17, 2008

(30) Foreign Application Priority Data
Mar. 20, 2006 (JP) 2006-077253

(51) Int. Cl. B01J 23/14; B01J 23/75; B01J 23/745; B01J 23/755; C01B 31/02

(52) U.S. Cl. 423/445 B; 502/352; 502/325; 502/338; 502/337; 977/843

(57) ABSTRACT

Catalyst particles for production of carbon nanocoil, even when a technique of gas-phase catalystic chemical vapor deposition method is employed, realizes high growth yield of carbon nanocoil, ensuring speedy growth of carbon nanocoil and simple production thereof: a process for producing the same; and a process for producing a carbon nanocoil. As catalyst particles for producing a carbon nanocoil of 1000 nm or less in outer coil diameter, catalyst particles having a center portion that is a primary or secondary particle of SnO₂, and a primary or secondary particle of a transition metal or an oxide thereof attached around the center portion are provided.

### TECHNICAL FIELD

The present invention relates to catalyst particles for production of carbon nanocoil, a process for producing the same, and a process for producing the carbon nanocoil.

### BACKGROUND ART

Carbon nanocoils are highly expected to be usable as electromagnetic wave absorbing materials of high performance due to their electrical conductivity and coil-like shape. Further, their size of nano meter order spotlights carbon nanocoils as materials of springs and actuators for use in micro machines.

In 1994, Amelinckx et al. firstly reported how to produce a carbon nanocoil. Amelinckx et al. prepared fine particles of a metal catalyst of Fe, Co, Ni, or the like, and heated the vicinity of the metal catalyst to a temperature in a range of 600° C. to 700° C. Then, a gas such as acetylene or the like was flowed in contact with the metal catalyst, thereby producing the carbon nanocoil.

This method, however, produces carbon products in various shapes (such as linear, curved, coil-like shapes) made of graphite structure. Since then, many catalysts, production process, etc. have been reported, which are industrially applicable with high growth yield of carbon nanocoils, which are carbon products in coil-like shapes.

Catalysts with high growth yield of carbon nanocoils have been reported by the inventors of the present invention, which are catalysts of indium, tin, and iron types (For example, see Patent Documents 1 to 5).

In Patent Documents 1 and 2, three-component catalysts made from indium, tin, and iron, and processes for producing the same are firstly disclosed. Patent Document 3 discloses how to produce a carbon nanocoil by dispersing a powder catalyst into a reactor in such a manner that the powder catalyst are dispersed as particles in the reactor. Patent Document 4 describes that a carbon nanocoil can be produced with a two-component catalyst such as a catalyst of Fe and Sn. Patent Document 5 discloses how to control catalyst particles in size, in order to produce a carbon nanocoil with even shape.

[Patent Document 1] Japanese Patent Application Publication, Tokukai, No. 2001-192204 (published on Jul. 17, 2001)

[Patent Document 2] Japanese Patent Application Publication, Tokukai, No. 2001-310130 (published on Nov. 6, 2001)
[Patent Document 3] Japanese Patent Application Publication, Tokukai, No. 2003-26410 (published on Jan. 19, 2003)
[Patent Document 4] Japanese Patent Application Publication, Tokukai, No. 2003-200053 (published on Jul. 15, 2003)
[Patent Document 5] Japanese Patent Application Publication, Tokukai, No. 2004-261630 (published on Sep. 24, 2004)

### DISCLOSURE OF INVENTION

### Technical Problem of the Present Invention

However, the conventional catalysts for the production of carbon nanocoils are not sufficient for industrial application.

For mass-synthesis of carbon nanocoil and reduction of carbon byproduct produced in use of a film-shaped catalyst, it is desirable to float a catalyst inside the reactor and synthesize the carbon nanocoil on a catalyst surface (gas-phase deposition method). However, the conventional catalysts have a low yield of carbon nanocoils when the particles of the conventional catalysts are dispersed. Moreover, the gas-phase deposition method requires the carbon nanocoil to be produced in a short time.

Moreover, as described above, various catalysts have been reported as a result of many researches on catalysts. However, these catalysts require complicated production processes and their particles should be calcinated at high temperatures. Thus, there is a demand for a simpler production method for producing such a catalyst.

Furthermore, the conventional two-component catalyst is poor in yield of carbon nanocoil, despite its advantage in that it does not require indium, which is high in cost. For efficient production of carbon nanocoil, a catalyst for attaining higher ratio of the coil in growing carbon products should be developed.

The present invention is accomplished in view of the aforementioned product. An object of the present invention is to realize (i) two-component catalyst particles for producing carbon nanocoil, (ii) a process for producing the two-component catalyst particles, and (iii) a process for producing the carbon nanocoil, which catalyst particles provide high growth yield of a carbon nanocoil even if the gas-phase synthesis is adopted, and allow the carbon nanocoil to grow in short time and simpler production of the carbon nanocoil.

### Means to Solve the Problem

As a result of diligent studies in view of the aforementioned problems, the inventors of the present invention found that if catalyst particles for catalytic chemical vapor deposition method have a particular structure, a high growth yield of a carbon nanocoil can be attained even if the carbon nanocoil synthesis is carried out with the catalyst particles dispersed in a reactor. The present invention is accomplished based on this finding.

Catalyst particles according to the present invention are catalyst particles for producing a carbon nanocoil of 1000 nm or less in outer coil diameter by a catalytic chemical vapor deposition method, each catalyst particle comprising: a center portion which is a primary or secondary particle made from SnO₂; and a primary or secondary particle of a transition metal or an oxide thereof, attached around the center portion.

With this structure, it is possible to produce the carbon nanocoil with a high growth yield even by the catalytic chemical vapor deposition method in which the catalyst is floated in a reactor and the carbon nanocoil is synthesized on the surface of the catalyst.

It is preferable that the primary or secondary particle of SnO₂ as the center portion is not less than 50 nm but not more than 1000 nm in particle size.

With this structure, it is possible to produce the carbon nanocoil in high growth yield even by the catalytic chemical vapor deposition method in which the catalyst is floated in a reactor and the carbon nanocoil is synthesized on the surface of the catalyst.

It is preferable that the transition metal is Fe, Co, or Ni. It is preferable that the oxide of the transition metal is Fe₃O₄.

A process according to the present invention for producing catalyst particles for producing a carbon nanocoil is a process comprising: synthesizing metal particulates or metal oxide particulates of a transition metal by heating a salt or hydroxide of the transition metal in a polyol; refining the metal particulates or metal oxide particulates by washing the metal particulates or metal oxide particulates with or without separating the metal particulates or metal oxide particulates from the polyol, so as to obtain a dispersion solution in which the metal particulates or metal oxide particulates are dispersed in an organic solvent; and mixing SnO₂ powder into the dispersion solution.

With this arrangement, the need of baking the powder at a high temperature, thereby making it possible to produce the catalyst more easily. Moreover, it is possible to appropriately produce the carbon-nanocoil-producing particles as described above each comprising the center portion that is the particle of SnO₂, and the particle of the transition metal or oxide thereof.

With this arrangement, the vapor deposition method for producing the carbon nanocoil on the surface of the catalyst floated in the reactor can produce one carbon nanocoil from one catalyst particle. This makes it easier to collect the carbon nanocoil.

The catalyst particles according to the present invention may be catalyst particles for producing a carbon nanocoil, the catalyst particles being produced by the process.

Another process according to the present invention for producing catalyst particles for producing a carbon nanocoil is a process comprising: synthesizing a complex of SnO₂ and metal particulates or metal oxide particulates of a transition metal, by heating SnO₂ powder and a salt or hydroxide of the transition metal in a polyol; and refining the complex by washing the complex with or without the complex from the polyol, so as to obtain a dispersion solution in which the complex is dispersed in an organic solvent.

With this arrangement, the need of baking the powder at a high temperature, thereby making it possible to produce the catalyst more easily. Moreover, it is possible to appropriately produce the catalyst particles as described above each comprising the center portion that is the particle of SnO₂, and the particle of the transition metal or oxide thereof.

With this arrangement, the carbon nanocoil can be grown in a further shorter time. Thus, this process is suitable for the catalytic chemical vapor deposition method.

The catalyst particles according to the present invention may be catalyst particles for producing a carbon nanocoil, the catalyst particles being produced by the process.

It is preferable that the transition metal is Fe, Co, or Ni. It is preferable that the oxide of the transition metal is Fe₃O₄.

It is preferable that Fe₃O₄ particulates constituting the catalyst particles are secondary particles not less than 30 nm but not more than 300 nm in particle size, constituted by primary particles not less than 8 nm but not more than 15 nm in particle diameter.

A process according to the present invention for producing a carbon nanocoil is a process comprising: floating the catalyst particles, in a reactor in which a gas of a molecule as a carbon source, or a mixture of the gas and an inert carrier gas flows, so as to grow the carbon nanocoils on surfaces of the catalyst particles.

With this structure, it is possible to produce the carbon nanocoil in high growth yield even by the catalytic chemical vapor deposition method in which the catalyst is floated in a reactor and the carbon nanocoil is synthesized on a surface of the catalyst.

### EFFECT OF THE INVENTION

As described above, the catalyst particles according to the present invention for producing a carbon nanocoil each comprise: a center portion which is a primary or secondary particle made from SnO₂; and a primary or secondary particle of a transition metal or an oxide thereof, attached around the center portion. With this, the catalyst particles according to the present invention can grow a carbon nanocoil in high growth yield.

As described above, the process according to the present invention for producing catalyst particles for producing a carbon nanocoil is a process comprising: synthesizing metal particulates or metal oxide particulates of a transition metal by heating a salt or hydroxide of the transition metal in a polyol; refining the metal particulates or metal oxide particulates by washing the metal particulates or metal oxide particulates with or without separating the metal particulates or metal oxide particulates from the polyol, so as to obtain a dispersion solution being an solution in which the metal particulates or metal oxide particulates are dispersed in an organic solvent; and mixing SnO₂ powder into the dispersion solution. With this process, the need of baking the powder at a high temperature, thereby making it possible to produce the catalyst more easily. Moreover, it is possible to appropriately produce the catalyst particles as described above each comprising the center portion that is the particle of SnO₂, and the particle of the transition metal or oxide thereof.

As described above, the process according to the present invention for producing catalyst particles is a process comprising: synthesizing a complex of SnO₂ and metal particulates or metal oxide particulates of a transition metal, by heating SnO₂ powder and a salt or hydroxide of the transition metal in a polyol; and refining the complex by washing the complex with or without the complex from the polyol, so as to obtain a dispersion solution in which the complex is dispersed in an organic solvent. With this process, the need of baking the powder at a high temperature, thereby making it possible to produce the catalyst more easily. Moreover, it is possible to appropriately produce the carbon-nanocoil-producing particles as described above each comprising the center portion that is the particle of SnO₂, and the particle of the transition metal or oxide thereof.

### BRIEF DESCRIPTION OF DRAWINGS

FIG. 1 is a schematic view of a catalyst particle for production of carbon nanocoil according to the present invention.

FIG. 2 is a view showing x-ray diffraction of Fe₃O₄ particulates synthesized in Example 1.

FIG. 3 is a view showing a result of observation of the Fe₃O₄ particulates obtained in Example 1, the observation being carried out with a scanning electron microscope.

FIG. 4(a) is a view showing a result of observation of the Fe₃O₄ particulates of catalyst particles obtained in Example 1, the observation being carried out with a transmission electron microscope.

FIG. 4(b) is a view showing a result of observation of the Fe₃O₄ particulates of the catalyst particles obtained in Example 1, the observation being carried out with a transmission electron microscope (×500,000).

FIG. 5(a) is a view showing a result of observation of the catalyst particles obtained in Example 1, the observation being carried out with a transmission electron microscope.

FIG. 5(b) is a view showing a result of observation of the catalyst particles obtained in Example 1, the observation being carried out with a transmission electron microscope.

FIG. 6 is a view showing a step of dispersing on the catalyst particles on a substrate in Examples 2 and 4.

FIG. 7 is a schematic view showing an apparatus used in carbon nanocoil synthesis carried out by catalytic chemical vapor deposition method.

FIG. 8 is a view showing a result of observation of a Si substrate by using a scanning electron microscope, the Si substrate being obtained by the carbon nanocoil synthesis in which catalyst particles of Fe₃O₄:SnO₂=1:5 were dispersed on a substrate in Example 2.

FIG. 9 is a view showing a result of observation of the catalyst particles obtained in Example 3, the observation being carried out by using a transmission electron microscope.

### EXPLANATION OF REFERENCE NUMERALS

1: Primary particle of SnO₂
2: Center portion
3: Particle of a transition metal or an oxide thereof
4: Primary particle of the transition metal or the oxide thereof
11: Quartz tube
12: Si Substrate
13: Tube Furnace
14: Temperature controller

### BEST MODE FOR CARRYING OUT THE INVENTION

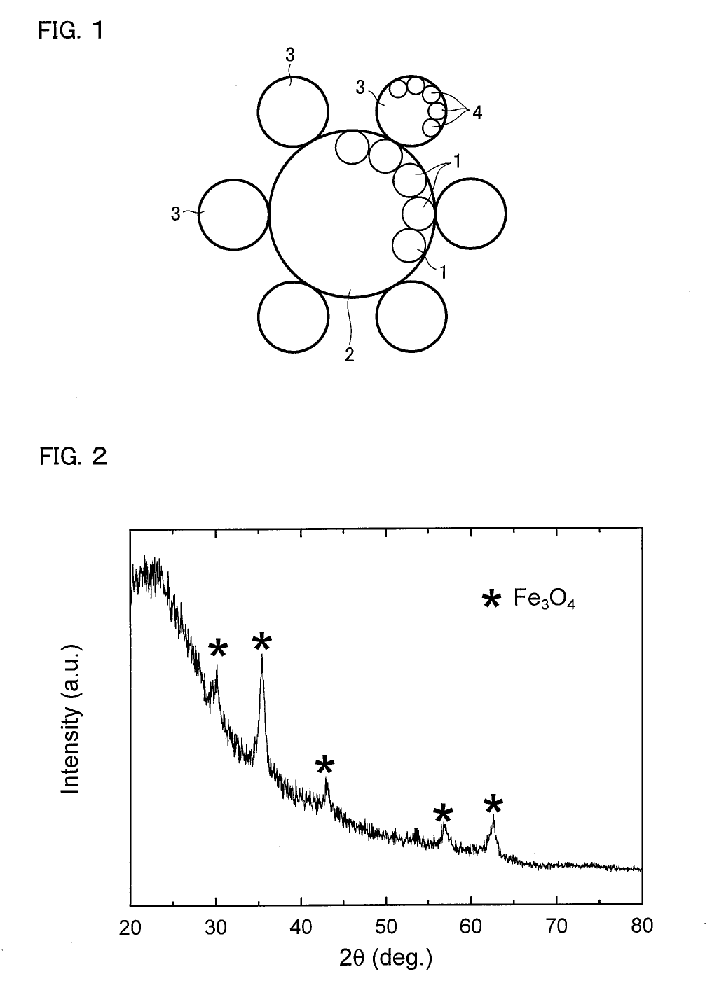

The present invention is described below referring to FIGS. 1 to 9.

### (1) Catalyst Particles for Producing a Carbon Nanocoil

Catalyst particles according to the present invention for use in production of a carbon nanocoil are a catalyst for producing a carbon nanocoil of 1000 nm or less in outer coil diameter by catalytic chemical vapor deposition method. The catalyst particles have a center portion that is a particle of SnO₂, and a particle of a transition metal or an oxide thereof attached to the center portion.

The catalyst particles according to the present invention are a catalyst for producing a carbon nanocoil of 1000 nm or less in outer coil diameter by catalytic chemical vapor deposition method. Here, the carbon nanocoil is any carbon nanocoil which is produced by growing a coil structure with carbon atoms helically oriented, and whose outer coil diameter is 1000 nm or less. Therefore, the carbon atoms helically oriented and thereby grown into a coil structure that may be a carbon nanotube that is hollow, or a carbon fiber that is not hollow inside. Moreover, the carbon nanocoil may be formed by helically winding plural carbon nanotubes or carbon fibers into a coil structure, which are hollow or not hollow inside.

The catalyst particles according to the present invention are a catalyst for use in the production of the carbon nanocoil by catalytic chemical vapor deposition method. Here, the catalytic chemical vapor deposition method is not particularly limited, provided that a gas of a molecule as a carbon source, or a mixture of the gas and an inert carrier gas is coexisted with a catalyst in a reactor, and subjected to a high process temperature thereby to grow the carbon nanocoil.

Therefore, in the production of the carbon nanocoil by catalytic chemical vapor deposition method by using the catalyst particles according to the present invention for producing the carbon nanocoil, there is no particular limitation as to the molecules as the carbon source, how to support the catalyst, a structure of the apparatus, a reaction temperature, a reaction pressure, a reaction time, the carrier gas, and the like. For example, the molecules as the carbon source may be a hydrocarbon such as acetylene, ethylene, methane, or the like. Moreover, the reaction temperature is in a range of 400° C. to 800° C. in general.

The catalyst particles according to the present invention are a catalyst for use in the production of the carbon nanocoil by catalytic chemical vapor deposition method, and has (i) a center portion, which is a primary particle or a secondary particle of SnO₂, and (ii) a primary particle or a secondary particle of a transition metal or an oxide thereof attached around the center portion. FIG. 1 schematically shows the catalyst particle according to the present invention. As shown in FIG. 1, the catalyst particle has a center portion 2 which is a particle of SnO₂, and particles 3 of the transition metal or the oxide thereof attached around the center portion 2. Here, the particle of SnO₂ constituting the center portion 2 may be a primary particle of SnO₂ or a secondary particle of SnO₂ formed by aggregating primary particles 1 of SnO₂. Moreover, the particle 3 of the transition metal or the oxide thereof may be a primary particle of the transition metal or the oxide thereof, or a secondary particle formed by aggregating the primary particles 4 of the transition metal or the oxide thereof.

Patent Document 4 has reported by the inventors of the present invention that a carbon nanocoil can be produced by catalytic chemical vapor deposition method with a two-component catalyst of SnO₂ and an oxide of Co or Ni. In Patent Document 4, there is a problem that the growing carbon products are mixtures of a carbon nanocoil, carbon nanotube, carbon nanotwist, and the like, and a ratio (yield) of the carbon nanocoil in the mixture is quite low. The catalyst particles according to the present invention with the above-mentioned structure can improve the ratio of the carbon nanocoil in the resultant carbon products.

The transition metal can be any transition metal. Among the transition metals, Fe, Co, Ni, and the like are preferable, and Fe is more preferable. With this, it is possible to produce carbon products with a higher ratio of the carbon nanocoil therein.

The oxide of the transition metal is not particularly limited, but is preferably an oxide of Fe, Co, Ni, or the like. Specific examples of the oxide encompass FeO, Fe₂O₃, Fe₃O₄, Co₃O₄, CoO, NiO, Ni₂O₃, NiO₂, and the like. Among them, the oxides of Fe are preferable and Fe₃O₄ is more preferable. The use of the oxide of Fe stabilizes the catalyst (makes the catalyst further inoxidizable). Further, Fe₃O₄ is preferable, because Fe₃O₄ is considered to be superior in catalyst activity to Fe₂O₃ that has been used in powder catalysts for the production of a carbon nanocoil conventionally.

In the catalyst particles according to the present invention, the center portion formed from one primary particle of SnO₂ or a secondary particle formed by aggregating the primary particles 1 of SnO₂. A particle size of the primary or secondary particle of SnO₂ as the center portion, in other words, a particle size of the primary particle when the center portion 2 is made from one primary particle, or a particle size of the secondary particle when the center section 2 is made from the secondary particle is preferably not less than 50 nm but not more than 1000 nm. When the particle size of the primary or secondary particle of SnO₂ as the center portion is within the range, the production of the carbon nanocoil can be carried out appropriately. Moreover, the particle size of the primary or secondary particle of SnO₂ as the center portion is more preferably not less than 50 nm but not more than 700 nm, and further preferably not less than 50 nm but not more than 200 nm. The particle size of the primary or secondary particle of SnO₂ as the center portion within these ranges makes it possible to produce the carbon nanocoil more appropriately.

In the present specification, the particle size is a value determined in the following manner, unless otherwise specified. Firstly, samples are collected from several points in a solution in which the particles to be tested are dispersed. Each sample is observed under transmission electron microscope. From a microscopic photograph, 50 or more catalyst particles in total for the several samples as a whole are measured to find their long axis diameters (i.e., dimensions of the particles along a direction in which the particles have the largest dimension). From the population of the 50 or more measured values, upper and lower 20% thereof is subtracted, and the measured values in the remained 60% are averaged to determine the particle size in the present invention.

In the catalyst particles of the present invention, the particle 3 of the transition metal or the oxide thereof attached around the center portion 2 is also a primary particle or a secondary particle. A particle size of the primary or secondary particle of the transition metal or the oxide thereof attached around the center portion, in other words, a particle size of the particle 3 as a primary particle or particle size of the particle 3 as a secondary particle are preferably not less than 30 nm but not more than 300 nm. With this, the carbon nanocoil can be produced more appropriately. For example, in case where the catalyst particle is produced by using polyol as described later, the particle 3 of Fe₃O₄ (an oxide of a transition metal) is a secondary particle of not less than 30 nm but not more than 300 nm formed from primary particles of not less than 8 nm but not more than 15 nm, more preferably approximately 10 nm.

Moreover, the secondary particle 3 of the transition metal or the oxide attached around the center portion 2 made from SnO₂ is not particularly limited in terms of its number attached thereto. Thus, the many particles of the transition metal or the oxide thereof may surround the center portion, thereby forming a crust portion. As an alternative, plural particles of the transition metal or the oxide thereof may be attached around the center portion in such a manner that there are gaps between the particles of the transition metal or the oxide thereof. Further, a small number of the particles of the transition metal or the oxide thereof may be attached around the center portion.

Further, it is preferable that plural particles of the transition metal or the oxide thereof are attached around the center portion 2 made from SnO₂. However, it may be arranged such that only one particle of the transition metal or the oxide thereof is attached around the center portion 2, provided that a SnO₂—Transition metal or oxide thereof—SnO₂ structure is not formed (another SnO₂ is not attached to the particle of the transition metal or the oxide thereof attached to one SnO₂). Again in this case, it is possible to produce a carbon nanocoil.

Moreover, again in the case where the plural particles 3 of the transition metal or the oxide thereof are attached around the center portion 2 made from SnO₂, it is preferable that each catalyst particle exist independently from each other and does not in such a SnO₂—Transition metal or oxide thereof—SnO₂ structure is not formed (another SnO₂ is not attached to the particle of the transition metal or the oxide thereof attached to one SnO₂). The presence of a SnO₂—Transition metal or oxide thereof—SnO₂ structure is not preferable because it stops the growth of the carbon nanocoil.

It is possible to confirm the structure of the catalyst particles by using a transmission electron microscope. Moreover, by compositional analysis (EDAX: Energy dispersive x-ray fluorescence spectrometry), it is possible to confirm that a particle in a transmission electron microscopic image is a certain particle.

### (2) Process for Producing Catalyst Particles for Producing a Carbon Nanocoil

Process according to the present invention for producing catalyst particles for producing a carbon nanocoil is not particularly limited, provided that the process can produce the catalyst particles having the aforementioned structure. For example, a method is preferable, which includes synthesizing metal particulates metal oxide particulates by heating a salt or a hydroxide of the transition metal in a polyol.

This method applies a polyol technique, which is known as a technique suitable for synthesizing metal particulates of nano and micrometer sizes by reducing a metal salt or a metal hydroxide in a polyol. The metal particulate synthesis by the polyol technique is carried out by dissolving a precursor of the metal salt or metal hydroxide into the polyol, reducing the dissolved precursor with the polyol, forming and growing seeds of the metal particulates in the solution. The inventors of the present invention expected that the polyol technique might be adopted to mass production of the catalyst, and actually tried to produce the catalyst with a Fe salt. Thereby, the inventors of the present invention found that the metal oxide particles can be produced with the polyol technique. Further, the inventors of the present invention found that particles obtained by mixing the metal oxide particles with SnO₂ particles had the aforementioned structure that has a center portion made from SnO₂, and a metal oxide particle attached around the center portion, and that it was possible to produce a carbon nanocoil in high growth yield by using the catalyst particles with such a structure. Based on these findings, it is expected to produce a catalyst having a similar structure, from metal particles obtained by the polyol technique.

As examples of the process for producing the catalyst particles according to the present invention, the following discusses two embodiments in which the steps of synthesizing metal particulates or metal oxide particulates by heating a salt or peroxide of a transition metal in a polyol.

(2-1)

In a first embodiment, metal particulates or metal oxide particulates are synthesized by heating a salt or peroxide of a transition metal in a polyol, and the resultant metal particulates or metal oxide particulates are mixed with SnO₂ powder thereby to produce catalyst particles according to the present invention. Hereinafter, the catalyst particles produced by the production process according to the present embodiment may be referred to as “mix catalysts” where appropriate, for the sake of easy explanation.

The process according to the present embodiment for producing the catalyst particles should comprise the metal particulate synthesis step for heating a salt or hydroxide of a transition metal in a polyol, so as to synthesize metal particulates or metal oxide particulates made therefrom; the refining step for washing the synthesized metal particulates or metal oxide particulates with or without separating the metal particulates or metal oxide particulates from the polyol, so as to obtain a dispersion solution in which the metal particulates or metal oxide particulates are dispersed in an organic solvent; and the mixing step for mixing SnO₂ powder in the dispersion solution.

### <Metal Particulate Synthesis Step>

The metal particulates synthesis step is not particularly limited, provided that the step includes heating a salt or hydroxide of a transition metal in a polyol, so as to synthesize metal particulates or metal oxide particulates made therefrom. The heating of the salt of the transition metal is preferably carried out under the presence of a base. This induces the generation of the metal peroxide that is a precursor for the particulate synthesis, thereby leading to efficient synthesis of the metal particulates or the metal oxide particulates.

The transition metal may be any transition metal, but Fe, Co, Ni, and the like are more preferable as the transition metal. The metal salt of the transition metal is not particularly limited, but metal salts of Fe, Co, Ni, or the like are more preferable. Specific examples of the metal salts encompass: chlorides such as FeCl₂, FeCl₃, CoCl₂, CoCl₃, NiCl₂, NiCl₃, and the like; nitrates such as Fe(NO₃)₂, Fe(NO₃)₃, Co(NO₃)₂, Ni(NO₃)₂, and the like; sulfates such as FeSO₄, CoSO₄, NiSO₄, and the like; acetates such as iron acetate, cobalt acetate, nickel acetate, and the like; acetyl acetonates such as iron acetyl acetonate, cobalt acetyl acetonate, nickel acetyl acetonate, and the like; and hydrates of them. It is more preferable that the metal salt be FeCl₂ or a hydrate thereof, or FeSO₄ or hydrate thereof among them.

The polyol is a complex having two or more alcoholic hydrate groups in its molecule. The polyol is not particularly limited, provided that the metal particulates or metal oxide particulates are generated when the polyol and the metal salt or metal hydroxide are heated together. Specific examples of the polyol encompass ethylene glycol, propylene glycol, butanediols such as 1,4-butanediol, pentanediols such as 1,5-pentanediol, diethylene glycol, triethylene glycol, tetraethylene glycol, polyethylene glycol, etc. The polyols may be used solely or two or more of them may be used in combination. Among them, ethylene glycol is more preferable as the polyol. A reason why the polyol is used in the present invention is because polyols are higher in boiling point than other solvent, and thus make it easier for the particulates to crystallize in the particulate synthesis, and polyols have reducing power to allow the synthesis of the metal particulates.

It is preferably that the metal salt or the metal hydroxide be soluble in the polyol. However, even if the metal salt or metal hydroxide is insoluble, the present invention is still workable by causing the reaction with the metal salt or metal hydroxide dispersed in the polyol.

As to the amount of the metal salt or metal hydroxide to be used with respect to the polyol, it is preferable that the metal salt or the metal hydroxide is not less than 0.05 mol but not more than 0.5 mol per 1 L of the polyol, more preferably not less than 0.05 mol but not more than 0.2 mol per 1 L of the polyol. An amount of the metal salt or metal hydroxide less than 0.05 mol per 1 L of the polyol is not preferable because the predetermined particulates cannot be synthesized. An amount of the metal salt or metal hydroxide more than 0.5 mol per 1 L of the polyol is not preferable because resultant particulates have excessively large particle sizes.

The base is not limited to a particular kind. For example, sodium hydroxide, potassium hydroxide, or the like may be used as the base. Among them, sodium hydroxide is more preferable as the base. As to the amount of the base to be added, the base not less than 0.5 mol but not more than 1.5 mol should be added per 1 L of the polyol solution. An amount of the base less than 0.5 mol does not allow the particulate synthesis and thus is not preferable. Moreover, with an amount of the base more than 1.5 mol, some base remains in the polyol solution without being dissolved. Therefore, the amount of the base more than 1.5 mol is not preferable.

In this step, it is preferable that the heating of the metal salt or the metal hydroxide is carried out at 150° C. or higher if this step is carried out at normal pressure. Further, the reaction may be carried out in the polyol being boiled, whereby the reaction can be carried out at a temperature corresponding to a boiling point of the polyol.

### <Refining Step>

In the refining step, the metal particulates or the metal oxide particulates thus synthesized are washed with or without being separated, thereby obtaining a dispersion solution in which the metal particulates or the metal oxide particulates are dispersed in an organic solvent. The refining step may be carried out in any way. For example, the following method can be suitably adopted. After the metal particulates or the metal oxide particulates are separated from the polyol solution, the metal particulates or the metal oxide particulates thus separated are washed with the organic solvent. After the washing is completed, the dispersion solution of the metal particulates and the metal oxide particulates is obtained. There is no particulate limitation regarding how to separate the metal particulates or metal oxide particulates from the polyol solution in which the metal particulates or metal oxide particulates are contained. For example, ordinary decantation can be adopted in the present invention. Moreover, if the metal particulates or metal oxide particulates are magnetic such as Fe and Fe₃O₄, a magnet may be used to separate the metal particulates or metal oxide particulates from the polyol solution. In this case, for example, it may be arranged such that the metal particulates or the metal oxide particulates are gathered at a bottom of a counter by using the magnet, and after a supernatant is removed therefrom, the organic solvent for washing is added thereto, so a to wash the metal particulates or the metal oxide particulates. The use of magnet makes it possible to efficiently separate the metal particulates or the metal oxide particulates from the polyol solution.

The organic solvent is not limited to a particular kind, but is preferably a complex having a relatively low boiling point. The use of an organic solvent having a low boiling point makes it easier to volatilize off the organic solvent.

Specific examples of the organic solvent encompass: alcohols such as methanol, ethanol, 1-propanol, 2-propanol, 1-butanol, 2-butanol, isobuthyl alcohol, and isopenthyl alcohol; ketones such as acetone, 2-butanone, 3-pentanone, methylisopropyl ketone, methyl n-propyl ketone, 3-hexanone, and methyl n-butyl ketone; ethers such as diethyl ether, diisopropyl ether, tetrahydrofuran, and tetrahydropyran; lower saturated hydrocarbone, pentane, hexane, and cyclohexane; esters such as acetic ethyl ester; dimethylsulfoxide (DMSO); N,N-dimethyl formamide (DMF), N,N-dimethylacetamide, N-methylpyrrolidone, and hexamethylphosphoric triamide (HMPA); nitrites such as acetonitrile; and the like.

### <SnO₂ Powder Mixing Step>

In the SnO₂ powder mixing step, the SnO₂ powder is mixed in the resultant dispersion solution of the metal particulates or metal oxide particulates. The SnO₂ powder to be mixed in may be commercially available one or may be synthesized by a well-known method. Moreover, the SnO₂ powder used in this step is not particularly limited in terms of its particle size. For example, the SnO₂ powder may be not less than 50 nm but not more than 1000 nm in particle diameter preferably.

There is no particular limitation as to a ratio between the SnO₂ powder to be mixed in and the metal particulates or metal oxide particulates. The ratio may be selected appropriately depending on various factors such as how to introduce the catalyst particles in the carbon nanocoil synthesis using the catalytic chemical vapor deposition method.

For example, in case where the carbon nanocoil synthesis using the catalytic chemical vapor deposition method is carried out in such a manner that the catalyst particles in high density are introduced, such as in case where a concentrated dispersion solution of the catalyst particles is applied on, for example, a substrate so as to make a film thereof on the substrate and dried thereon, the ratio (weight of transition metal or oxide thereof/weight SnO₂) is preferably a finite value not less than 0.5, and more preferably a finite value not less than 1.5. If the ratio was less than 0.5, SnO₂ particles adjacent to each other in the catalyst would interact with each other, thereby leading to a lower growth yield of the carbon nanocoil.

Moreover, for example, in the arrangement where the catalyst is floated in the reactor so as to synthesize the carbon nanocoil on the surface of the catalyst, the catalyst particles would be introduced in a diluted manner, such as dropping a diluted solution of the catalyst particles on a substrate and spin-coating it thereon. In this case, the ratio (weight of transition metal or oxide thereof/weight SnO₂) is preferably in a ratio of not less than 0 but not more than 2, and more preferably in a ratio of not less than 0 but not more than 1.5. In case where the carbon nanocoil synthesis using the catalytic chemical vapor deposition method is carried out in which the catalyst particles are introduced in such a dispersed form, this makes it possible to form such catalyst particles in a high ratio that have (i) the center portion made from a SnO₂ particle and the particle of the transition metal or oxide thereof attached around the center portion.

Moreover, in case of catalyst particles used in conventional carbon nanocoil production methods, high-temperature calcination is necessary. The use of the process for producing the catalyst particles according to the present embodiment makes it possible to produce catalyst particles with high crystallinity because the salt or hydroxide of the transition metal is heated in the polyol at the temperature around the boiling temperature of the polyol. Therefore, the present invention makes it possible to easily produce catalyst particles without the need of the baking step. Moreover, the process according to the present invention is a process for producing catalyst particles by using a solution method. Therefore, the process according to the present invention is suitable for mass production.

(2-2)

Next, in a second embodiment, a salt or a hydroxide of a transition metal and SnO₂ powder are heated in a polyol, so as to produce catalyst particles according to the present invention for producing a carbon nanocoil. Hereinafter, the catalyst particles produced by the process according to the present embodiment are referred to as “complex catalyst” where appropriate, for the sake of easy explanation.

The process according to the present embodiment for producing the catalyst particles at least comprises: the complex synthesis step for synthesizing a complex by heating (i) a salt or a hydroxide of a transition metal and (ii) SnO₂ powder in a polyol, so as to synthesize a complex made from metal particulates or metal oxide particulates, and SnO₂; and the refining step for washing the complex with or without separating the particulates from the polyol, so as to obtain a dispersion solution in which the complex are dispersed in an organic solvent.

### <Complex Synthesis Step>

The complex synthesis step should be arranged at least such that a salt or a hydroxide of a transition metal and SnO₂ powder are heated in a polyol, so as to synthesize a complex made from metal particulates or metal oxide particulates, and SnO₂. In case the salt of the transition metal is used, it is preferable that the heating the transition metal salt in the polyol is carried out in the presence of a base, for the reason explained in (2-1).

What is described in (2-1) is also true in the present embodiment, regarding (i) the salt or hydroxide of the transition metal, (ii) the polyol, (iii) the amount of the salt or hydroxide of the transition metal with respect to the polyol, (iv) the base, (v) the amount of the base, (vi) the temperature of the heating, and (vii) the SnO₂ powder. Therefore, their explanation is omitted here.

It is preferable that the salt or hydroxide of the transition metal and the SnO₂ powder be soluble in the polyol. However, even if either of them is insoluble, the present invention is still workable by causing the reaction with the metal salt or metal hydroxide, or the SnO₂ powder dispersed in the polyol.

Moreover, the ratio of the SnO₂ powder and the metal salt or the metal hydroxide to be mixed in is not particularly limited, and the ratio of the SnO₂ powder and the metal salt or metal hydroxide particles in the resultant carbon nanocoil catalyst particles is not particularly limited. The ratio of the SnO₂ powder and the metal salt or metal hydroxide particles may be selected approximately depending on various factors such as how to introduce the catalyst particles in the carbon nanocoil synthesis using the catalytic chemical vapor deposition method.

For example, in the arrangement where the catalyst is floated in the reactor so as to synthesize the carbon nanocoil on the surface of the catalyst, the catalyst particles would be introduced in a diluted manner, such as dropping a diluted solution of the catalyst particles on a substrate and spin-coating it thereon. In this case, the ratio (weight of transition metal or oxide thereof/weight SnO₂) is preferably in a ratio of not less than 0.4 but not more than 2, and more preferably in a ratio of not less than 0.7 but not more than 1.5. In case where the carbon nanocoil synthesis using the catalytic chemical vapor deposition method is carried out in which the catalyst particles are introduced in such a dispersed form, this makes it possible to form such catalyst particles in a high ratio that have (i) the center portion made from a SnO₂ particle and the particle of the transition metal or oxide thereof attached around the center portion.

Moreover, in case of catalyst particles used in conventional carbon nanocoil production methods, high-temperature calcination is necessary. The use of the process for producing the catalyst particles according to the present embodiment makes it possible to produce catalyst particles with high crystallinity because the salt or hydroxide of the transition metal is heated in the polyol at the temperature around the boiling temperature of the polyol. Therefore, the present invention makes it possible to easily produce catalyst particles without the need of the baking step. Moreover, the process according to the present invention is a process for producing catalyst particles by using a solution method. Therefore, the process according to the present invention is suitable for mass production.

### <Refining Step>

In the refining step, a complex of SnO₂ and the metal particulates or the metal oxide particulates thus synthesized is washed, with or without separating the complex from the polyol, so as to obtain a dispersion solution with an organic solvent. What is described in (2-1) is also true in the refining step. Therefore, its explanation is omitted here.

### (3) Production Process of Carbon Nanocoil

As described above, the catalyst particles according to the present invention make it possible to grow a carbon nanocoil in high growth yield, even if the carbon nanocoil synthesis in which the catalyst is floated in a reactor so as to synthesize the carbon nanocoil on the surface of the catalyst is carried out in such a manner that the catalyst is introduced in a dispersed form such as by dropping a diluted solution of the catalyst particles on a substrate and spin-coating it on the substrate. Such a synthesis method in which the catalyst is floated in the reactor so as to synthesize the carbon nanocoil on the surface of the catalyst, is a highly desirable method for mass-production of the carbon nanocoil, and for reducing carbon byproduct that is produced in the case where a film-shaped catalyst is used.

Therefore, the present invention encompasses such a process for producing a carbon nanocoil by floating the catalyst particles according to the present invention in a reactor in which a gas of a molecule that functions as a carbon source, or a mixture gas of the gas and an inert carrier gas is flowed, and growing the carbon nanocoil on the surface of the catalyst particles.

The molecule as the carbon source herein is described in (1), and its explanation is omitted here. Moreover, any inert gas can be used as the carrier gas. For example, nitrogen, argon, helium, or the like can be used suitably. Moreover, the reactor is not particularly limited in terms of its structure, and any reactor can be used.

How to float the catalyst particles according to the present invention is not particularly limited. For example, this can be done by spraying, via a spraying nozzle, a diluted dispersion solution in which the catalyst particles according to the present invention are dispersed in an organic solvent.

The process according to the present invention for producing the carbon nanocoil is not limited to this. The introduction of the catalyst particles according to the present invention into the reactor can be carried out by dispersing the catalyst particles according to the present invention on a substrate, or forming a film of the catalyst particles according to the present invention on a substrate.

### EXAMPLES

The present invention is described below via Examples, referring to FIGS. 2 to 9. It should be noted that the present invention is not limited thereto, and that persons skilled in the art can make various changes, adjustments, and/or modifications within the scope of the present invention.

### Example 1

### Production of Catalyst Particles (Mix Catalyst) for Producing Carbon Nanocoil

By heating FeCl₂.4H₂O in ethylene glycol, Fe₃O₄ particulates were synthesized. The Fe₃O₄ particulates thus obtained was mixed with SnO₂ powder. In this way, catalyst particles according to the present invention were produced.

### <Fe₃O₄ Synthesis Step>

Into 30 mL of ethylene glycol, 0.003 mol (0.583 g) of FeCl₂.4H₂O was added, and stirred at room temperature until iron chloride was completely dissolved therein. By this, 30 mL of an ethylene glycol solution with Fe²⁺ concentration of 0.1 mol/L was prepared.

While stirring the ethylene glycol solution thus obtained, 1.4 to 1.5 g of sodium hydroxide powder was added to the ethylene glycol solution. Upon the addition of sodium hydroxide, the ethylene glycol solution changed its color into dark green immediately. Soon after the color change, the dark green solution was heated so as to reach 100° C., and then stirred at 100° C. until sodium hydroxide was completely dissolved.

The ethylene glycol solution in which sodium hydroxide was completely dissolved was boiled by rapidly heating it to reach its boiling point from 100° C. in several minutes. It is considered that the temperature of the boiling solution was approximately 195° C., which is the boiling point of ethylene glycol.

The boiling solution was further boiled for several to 5 minutes with stirring. As a result, the dark green solution turned into black. This indicated that the Fe₃O₄ particulates were synthesized. The resultant black solution was cooled down to room temperature with stirring. Assuming that iron ions were completely reacted, the Fe₃O₄ particulates were obtained in an amount of 0.001 mol (0.23065 g).

### <Refining Step>

By using a magnet, the ethylene glycol solution of the Fe₃O₄ particulates thus obtained was separated into the Fe₃O₄ particulates and the solvent (ethylene glycol+sodium ions+chloride ions+unreacted OH—). More specifically, the Fe₃O₄ particulates being magnetic were gathered at a bottom of a beaker by placing the beaker on the magnet.

Then, a supernatant in the beaker was removed. And then the Fe₃O₄ particulates were washed with ethanol added in the beaker (by adding about 50 mL of ethanol into the beaker of 100 mL). In this way, the sodium ions, chloride ions, and unreacted OH— ions were removed.

The washing of the Fe₃O₄ particulates was carried out by repeating this operation 2 or 3 times. In the last round of the washing, the supernatant was not removed, thereby obtained a dispersion solution in which the Fe₃O₄ particulates were dispersed in ethanol.

### <SnO₂ Mixing Step>

Into the dispersion solution thus obtained, 1.15 g of commercially-available SnO₂ powder (Kishida Chemical Co., Ltd.) was added. Then, the dispersion solution was “gently” stirred by using a plastic spoon or the like. Thereby, catalyst particles were obtained. This stirring for dispersion solution should not be carried out supersonically or by using a homogenizer, because such stirring methods will break catalyst structures. A weight ratio of Fe₃O₄:SnO₂ was 1:5 ((weight of Fe₃O₄/weight of SnO₂)=0.2).

### <Identification of Fe₃O₄ Particulates>

The Fe₃O₄ particulates thus obtained after the refining step were dried and analyzed by X-ray diffraction, which was carried out with RINT 2500 (Rigaku Corp.) using CuK α ray (λ=0.154 nm). FIG. 2 shows a result of the X-ray diffraction. As shown in FIG. 2, a diffraction pattern thus obtained indicated that the particulate thus synthesized had a spinel structure. The peak labeled with an asterisk is the pattern of Fe₃O₄ in FIG. 2. Moreover, from the black color of the particulates, it was determined that the particulates thus synthesized were Fe₃O₄ particulates.

### <Observation of Fe₃O₄ Particulates by Scanning Electron Microscope>

The Fe₃O₄ particulates thus obtained were observed by a scanning electron microscope to find a shape and particle diameter thereof. The scanning electron microscopic observation was carried out by using JSM-7401F (JEOL Ltd.), and a sample thereof was the dispersion solution in which the Fe₃O₄ particulates were dispersed in ethanol.

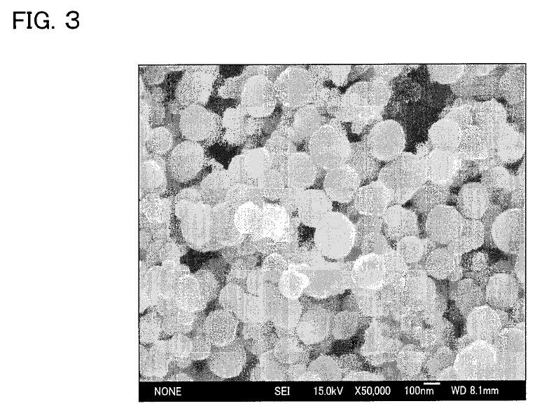

FIG. 3 shows a result of the scanning electron microscopic observation of the Fe₃O₄ particulates thus obtained. The scale bar in FIG. 3 shows 100 nm. Fifty or more particles were randomly sampled from the scanning electron microscopic photograph and measured in diameters (for spherical particles) or longitudinal diameters (for non-spherical particles) of the particles based on the scanning electron microscopic photograph. As a result, it was found that the particle sizes of the Fe₃O₄ particulates were widely distributed in a range of several tens of nm to 250 nm.

### <Observation of Fe₃O₄ Particulates by Transmission Electron Microscope>

The Fe₃O₄ particulates thus obtained were observed by a transmission electron microscope. The transmission electron microscopic observation was carried out by using HF-2000 (Hitachi, Ltd.). A sample thereof was a diluted ethanol dispersion solution, one drop of which was placed on a grid. The diluted ethanol dispersion solution was prepared by dropping, into 100 mL or more ethanol, 1 mL of the dispersion solution in which the Fe₃O₄ particulates were dispersed in ethanol.

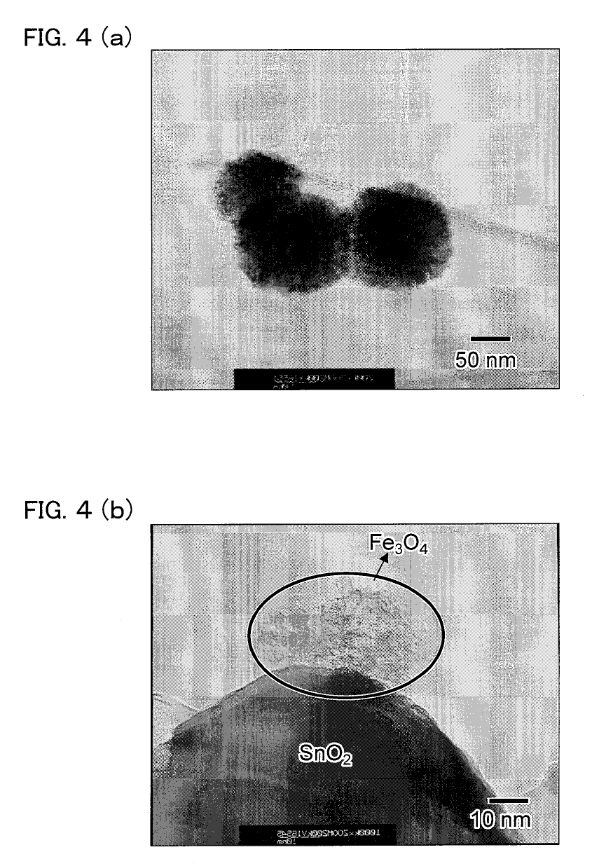

Firstly, the Fe₃O₄ particulates were observed in terms of the shape thereof and whether there was any agglomerate. FIGS. 4(a) and 4(b) show the results of the observation of the Fe₃O₄ particulates. The scale bar in FIG. 4(a) shows 50 nm and the scale bar in FIG. 4(b) shows 10 nm. FIG. 4(a) shows a portion in which only the Fe₃O₄ particulates were populated, and FIG. 4(b) shows a portion in which the Fe₃O₄ particulates and SnO₂ coexisted. From the result of the observation shown in FIG. 4(b) (×500,000), it was found that the Fe₃O₄ particulates shown in FIG. 4(a) were secondary particles constituted by primary particles of several nm in size.

It was confirmed by compositional analysis using EDAX (Energy dispersive X-ray Fluorescence Spectrometry) attached to the transmission electron microscope that the particles in the transmission electron microscopic image were particles constituted by Fe atoms (here, Fe₃O₄ particulates) or particles constituted by Sn atoms (here, SnO₂ particles).

As shown in FIGS. 4(a) and 4(b), the catalyst particles thus obtained had the portion where only the Fe₃O₄ particulates were populated, and the portion where Fe₃O₄ and SnO₂ coexisted. The portion where Fe₃O₄ and SnO₂ coexisted was greater in ratio than the portion where only the Fe₃O₄ particulates were populated.

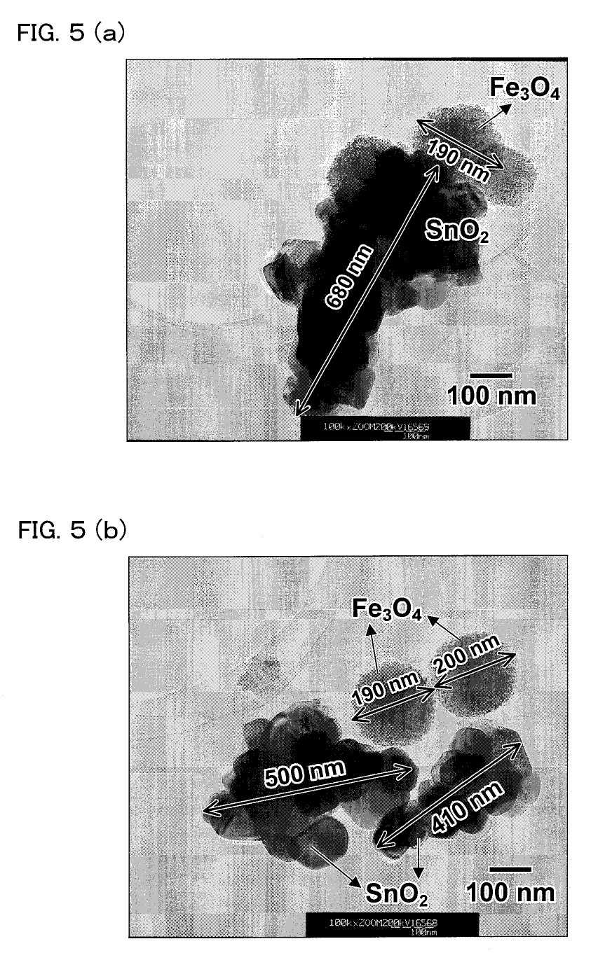

FIGS. 5(a) and 5(b) show the results of the transmission electron microscopic observation of the portion in which Fe₃O₄ and SnO₂ coexisted. In FIGS. 5(a) and 5(b), the scale bars indicate 100 nm. As shown in FIGS. 5(a) and 5(b), it was confirmed that primary particles of SnO₂ were aggregated to form secondary particles of several hundreds of nm in size. Around the secondary particle of SnO₂, secondary particles of Fe₃O₄ of approximately 200 nm in particle size were attached. As described later, it was found that, when each individual catalyst particle has such a structure, it grows a carbon nanocoil therefrom in case where a diluted ethanol dispersion solution of the catalyst particles thus obtained is dispersed so as to produce the carbon nanocoil by the catalytic chemical vapor deposition method.

### Example 2

### Carbon Nanocoil Synthesis using Catalytic Chemical Vapor Deposition Method

### <Preparation of Catalyst Particles>

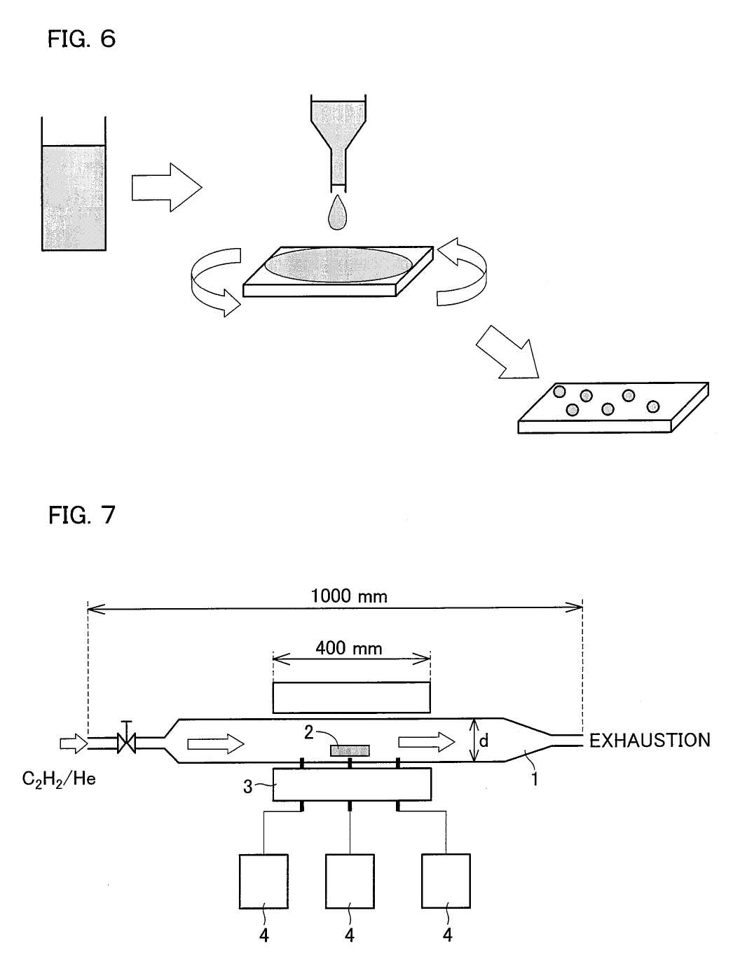

FIG. 6 shows the procedure. A diluted ethanol dispersion solution was prepared by dropping, into 100 mL or more of ethanol, 1 m of the ethanol dispersion solution of the catalyst particles obtained in Example 1, and then, “gently” stirring the resultant mixture.

A 1 cm×1 cm Si substrate was set on a spin coater. On the Si substrate thus set on the spin coater, a few drops of the diluted ethanol dispersion solution of the catalyst particles were dropped, and spin-coated for 2 minutes at 1500 rpm. Thereby, a Si substrate on which the catalyst particles were dispersed. Here, the Si substrate was used because the Si substrate is easy to cut out and easy to observe by the scanning electron microscope.

### <Carbon Nanocoil Synthesis>

A carbon nanocoil was synthesized by the catalytic chemical vapor deposition method using the catalyst particles thus obtained in Example 1. The synthesis used a CVD apparatus as shown in FIG. 7. As shown in FIG. 7, a quartz tube 11 of 1000 mm in length, and 26 mm or 46 mm in internal diameter d was used as a reactor, and set in a tubular furnace (length: 400 mm).

A Si substrate 12 thus prepared to have the catalyst particles thereon was set in a middle of the tubular furnace 13. Then the reactor was connected to a gas line and purged with helium for 15 minutes. Helium was flowed at a flow rate of 577 sccm if the internal diameter of the quartz tube 11 was 26 mm, or at a flow rate of 1740 sccm if the internal diameter of the quartz tube 11 was 46 mm.

Then, the reactor was heated to 700° C. After the temperature of the reactor was stabilized at 700° C., acetylene (C₂H₂) gas was flowed therethrough. Acetylene gas was flowed at a flow rate of 23 sccm if the internal diameter of the quartz tube 11 was 26 mm, or at a flow rate of 60 sccm if the internal diameter of the quartz tube 11 was 46 mm. That is, a total gas flow rate was 600 sccm if the internal diameter of the quartz tube 11 was 26 mm, or 1800 sccm if the internal diameter of the quartz tube 11 was 46 mm, and the mixture gas of helium and acetylene has an acetylene concentration of 3.3 to 3.8%.

After the acetylene gas was flowed for a predetermined time period, the reactor was naturally cooled. When the reactor reached 200° C. or below, the gas line was detached therefrom, and the Si substrate 12 was taken out.

### <Scanning Electron Microscopic Observation of Resultant Carbon Nanocoil>

The carbon nanocoil thus obtained was observed by using the scanning electron microscope, JSM-7401F (JEOL Ltd.).

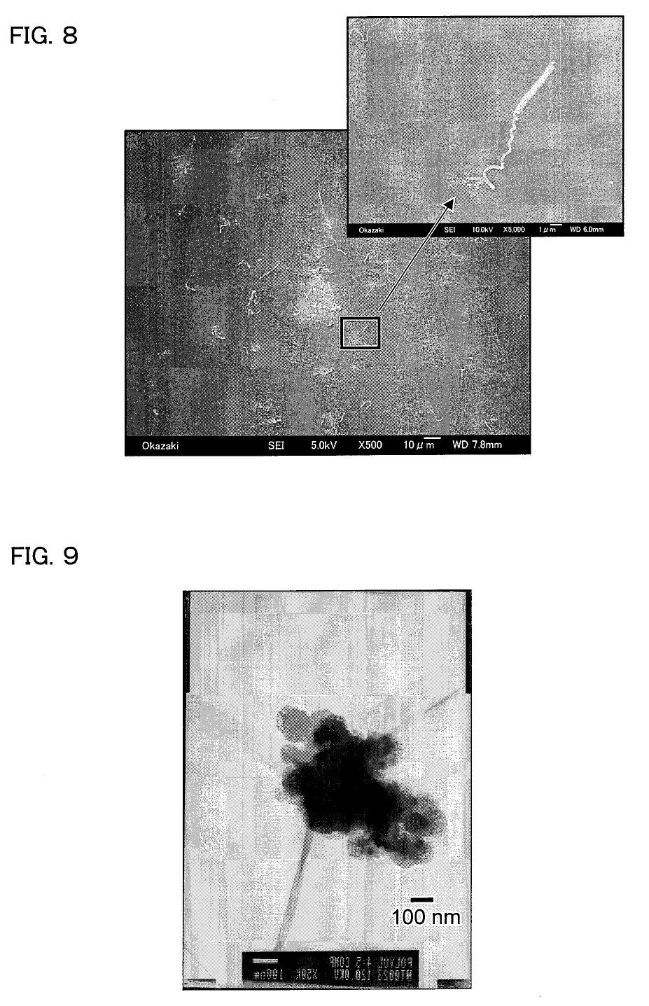

FIG. 8 shows a result of the scanning electron microscopic observation of the Si substrate obtained in the carbon nanocoil synthesis in which the catalyst particles obtained in Example 1 were dispersed on the Si substrate as described above and the Si substrate was then treated with 10-minute flow of acetylene gas. The scale bar in FIG. 8 is 10 μm. As shown in FIG. 8, it was found that the carbon nanocoils grew from individual catalyst particles having the structure that the secondary particles of Fe₃O₄ were attached around the secondary particle of SnO₂. Further, one carbon nanocoil was grown from each individual catalyst particle having the structure that the secondary particles of Fe₃O₄ were attached around the secondary particle of SnO₂. Therefore, the catalyst particles with such a structure have such an advantage that the carbon nanocoil produced by using the catalyst particles can be easily collected.

### <Yield of Carbon Nanocoil>

From the scanning electron microscopic observation, growth yields of the carbon nanocoil were investigated when the above-described carbon nanocoil synthesis and the catalyst particles thus obtained in Example 1 were used.

As a result, it was found that 43% of the whole catalyst particles (individual catalyst particles having the structure that the secondary particles of Fe₃O₄ were attached around the secondary particle of SnO₂) reacted to produce carbon products of some kind of 1 μm or longer in length. Meanwhile, 57% of the whole catalyst particles were remained unreacted. The reacted catalyst particles were divided into three categories. Only catalyst particles in the category I were counted as catalyst particles that produced the carbon nanocoil. The catalyst particles in the category I were catalyst particles from each of which one or more carbon nanocoils of 1 μm or longer in length were grown, and which were 500 nm or less in particle size. The catalyst particles in the category I accounted for 30% of the whole catalyst particles. Among the reacted 43% of the catalyst particles, catalyst particles in the category II accounted for 9%, catalyst particles in the category III accounted for 2%, and agglomerates of 500 nm or greater accounted for 2% of the whole catalyst particles. The catalyst particles in the category II were catalyst particles from each of which only a linear (fiber-like) carbon product of 1 μm or longer in length was grown, and which were 500 nm or less in particle size. The catalyst particles in the category III were catalyst particles from each of which only one or more double-helical products (carbon nanotwists) of 1 μm or longer in length were grown, or a double-helical product and linear (fiber-like) carbon product are co-grown.

From this result, it was found that the carbon nanocoil was grown from 71% of the whole catalyst particles from which carbon products of some kind of 1 μm or longer in length were grown. Thus, the yield of the carbon nanocoil was very large.

TABLE 1

| Category | Definition |
|---|---|
| I | catalyst particles from each of which |
| | one or more carbon nanocoils of 1 μm or |
| | longer in length were grown, and which |
| | were 500 nm or less in particle diameter |
| II | catalyst particles from each of which |
| | only a linear (fiber-like) carbon product |
| | of 1 μm or longer in length was grown, |
| | and which were 500 nm or less in |
| | particle size |
| III | catalyst particles from each of which |
| | only one or more double-helical |
| | products (carbon nanotwists) of 1 μm or |
| | longer in length were grown, or a |
| | double-helical product and linear |
| | (fiber-like) carbon product are co-grown |

This result demonstrated that the yield of the carbon nanocoil is very large in case where a diluted solution of catalyst particles was dropped on a substrate and thereby introduced in a dispersed form as in the present Example. Therefore, it was deduced from this result that a large yield of the carbon nanocoil can be attained in case where the catalyst is floated in a dispersed form in a reactor, so as to synthesize the carbon nanocoil on the surface of the catalyst.

### Example 3

### Production of Catalyst Particles (Complex Catalyst)

By heating FeCl₂.4H₂O and SnO₂ powder in ethylene glycol, a complex made from Fe₃O₄ particulates and SnO₂ was synthesized, thereby producing catalyst particles according to the present invention. In the present Example, two type of catalyst particles were produced, which had different weight ratios of Fe₃O₄:SnO₂ (=6:5 and 4:5).

### <Synthesis of Complex of Fe₃O₄ and SnO₂>

Firstly, 30 mL of an ethylene glycol solution of FeCl₂.4H₂O with Fe²⁺ ion concentration of 0.1 mol/L was prepared. Into the ethylene glycol solution, commercially-available SnO₂ powder (Kishida Chemical Co., Ltd.) was added with stirring. In the case where the catalyst particles having the weight ratio of Fe₃O₄:SnO₂=6:5 ((weight of Fe₃O₄/weight of SnO₂)=1.2), 0.1917 g of SnO₂ powder was added. In the case where the catalyst particles having the weight ratio of Fe₃O₄:SnO₂=4:5 ((weight of Fe₃O₄/weight of SnO₂)=0.8), 0.2875 g of SnO₂ powder was added.

After the addition of the SnO₂ powder, the ethylene glycol solution was stirred for 2 hours or longer. Then, 1.4 g to 1.5 g of sodium hydroxide powder was added to the ethylene glycol solution with stirring. Then, the ethylene glycol solution was heated to 100° C., and stirred at 100° C. until sodium hydroxide was completely dissolved. The solution changed its color to dark green after the addition of sodium hydroxide.

After sodium hydroxide was completely dissolved, the solution was boiled by heating it to its boiling point from 100° C. in several minutes. It is considered that the temperature of the boiling solution was approximately 195° C., which is the boiling point of ethylene glycol.

The boiling solution was further boiled for several to 5 minutes with stirring. As a result, the dark green solution turned into black. This indicated that the Fe₃O₄ particulates were synthesized. The resultant black solution was cooled down to room temperature with stirring. Thereby, an ethylene glycol solution of a complex of Fe₃O₄ and SnO₂ was obtained.

### <Refining Step>

By using a magnet, the ethylene glycol solution of the complex of Fe₃O₄ particulates and SnO₂ was separated into (i) the complex of Fe₃O₄ and SnO₂ and (ii) the solvent. More specifically, the complex being magnetic was gathered at a bottom of a beaker by placing the beaker on the magnet.

Then, a supernatant in the beaker was removed. And then the complex catalyst of the Fe₃O₄ particulates and SnO₂ was washed with ethanol added in the beaker (by adding about 50 mL of ethanol into the beaker of 100 mL). In this way, the sodium ions, chloride ions, and unreacted OH— ions were removed.

The washing of the complex catalyst of the Fe₃O₄ particulates and SnO₂ was carried out by repeating this operation 2 or 3 times. In the last round of the washing, the supernatant was not removed, thereby obtained a dispersion solution in which the complex catalyst of the Fe₃O₄ particulates and SnO₂ was dispersed in ethanol.

### <Transmission Electron Microscopic Observation of the Catalyst Particles>

The resultant catalyst particles having the weight ratio of Fe₃O₄:SnO₂=4:5 were observed by using the transmission electron microscope. In the transmission electron microscopic observation, a sample thereof was a diluted ethanol dispersion solution, one drop of which was placed on a grid. The diluted ethanol dispersion solution was prepared by dropping, into 100 mL or more ethanol, 1 mL of the dispersion solution in which the Fe₃O₄ particulates were dispersed in ethanol. FIG. 9 showed the result of transmission electron microscopic observation. The scale bar in FIG. 9 shows 100 nm. As shown in FIG. 9, many catalyst particles had the structure of SnO₂ particle, which was attached by secondary particle of Fe₃O₄ were observed.

### Example 4

### Carbon Nanocoil Synthesis Using Catalytic Chemical Vapor Deposition Method

### <Preparation of the Catalyst Particles (in Case of Dispersion Solution on Substrate)>

In the same manner as in Example 2, a Si substrate on which the carbon-nanocoil-producing particles obtained in Example 3 were dispersed.

### <Carbon Nanocoil Synthesis>

In the same manner as in Example 2, carbon nanocoil synthesis using the catalytic chemical vapor deposition method was carried out with the carbon nanocoil-producing particles obtained in Example 3. With the carbon nanocoil-producing particles obtained in Example 3, the carbon nanocoil could be synthesized in 3-minute reaction.

### <Yield of Carbon Nanocoil>

The catalyst particles obtained in Example 3 were dispersed on a substrate and subjected to 3-minute flow of acetylene gas in the method described above. A yield of the carbon nanocoil obtained in the carbon nanocoil synthesis described above was worked out from scanning electron microscopic observation in the same manner as in Example 2.

The observation showed that a ratio of (i) catalyst particles from which the carbon nanocoil was grown, over (ii) catalyst particles from which carbon products of some kind of 1 μm or longer in length was 35% in case where the weight ratio of Fe₃O₄:SnO₂ was 6:5 (weight of Fe₃O₄/weight of SnO₂)=1.2), and 34% in case where the weight ratio of Fe₃O₄:SnO₂ was 4:5 (weight of Fe₃O₄/weight of SnO₂)=0.8).

### INDUSTRIAL APPLICABILITY

By using catalyst particles according to the present invention, a process according to the present invention for producing the same, and a process according to the present invention for producing a carbon nanocoil, a high growth yield of the carbon nanocoil can be attained and the carbon nanocoil can be grown in a short time, even in a catalytic chemical vapor deposition method. Moreover, the catalyst particles according to the present invention can be produced more easily. Therefore, the present invention is not only applicable to industries in which carbon nanocoils are produced, but also electronic devices manufacturing industries etc. in which various products in which such carbon nanocoils are incorporated are manufactured. The present invention is expected to be very useful for these industries.

1. Catalyst particles for producing a carbon nanocoil of 1000 nm or less in outer coil diameter by a catalystic chemical vapor deposition method, each catalyst particle comprising:
a center portion which is a primary or secondary particle made from SnO₂; and
a primary or secondary particle of a transition metal or an oxide thereof, attached around the center portion.

2. The catalyst particles as set forth in claim 1, wherein the transition metal is Fe, Co, or Ni.

3. The catalyst particles as set forth in claim 1, wherein the primary or secondary particle of SnO₂ as the center portion is not less than 50 nm but not more than 1000 nm in particle size.

4. The catalyst particles as set forth in claim 1, wherein the oxide of the transition metal is Fe₃O₄.

5. A process for producing catalyst particles for producing a carbon nanocoil, the process comprising:
synthesizing metal particulates or metal oxide particulates of a transition metal by heating a salt or hydroxide of the transition metal in a polyol;
refining the metal particulates or metal oxide particulates by washing the metal particulates or metal oxide particulates with or without separating the metal particulates or metal oxide particulates from the polyol, so as to obtain a dispersion solution being an solution in which the metal particulates or metal oxide particulates are dispersed in an organic solvent; and
mixing SnO₂ powder into the dispersion solution.

6. A process for producing catalyst particles for producing a carbon nanocoil, the process comprising:
synthesizing a complex of SnO₂ and metal particulates or metal oxide particulates of a transition metal, by heating SnO₂ powder and a salt or hydroxide of the transition metal in a polyol; and
refining the complex by washing the complex with or without separating the complex from the polyol, so as to obtain a dispersion solution in which the complex is dispersed in an organic solvent.

7. The process as set forth in claim 5, wherein the transition metal is Fe, Co, or Ni.

8. The process as set forth in claim 5, to 7, wherein the oxide of the transition metal is Fe₃O₄.

9. The process as set forth in claim 8, wherein Fe₃O₄ particulates constituting the catalyst particles are secondary particles not less than 30 nm but not more than 300 nm in particle size, constituted by primary particles not less than 8 nm but not more than 15 nm in particle diameter.

10. Catalyst particles for producing a carbon nanocoil, the catalyst particles being produced by a process as set forth in claim 5.

11. A process for producing a carbon nanocoil, comprising:
floating catalyst particles for producing a carbon nanocoil, as set forth in claim 1, 2, 3, 4 or 10, in a reactor in which a gas of a molecule as a carbon source, or a mixture of the gas and an inert carrier gas flows, so as to grow the carbon nanocoil on surfaces of the catalyst particles.

12. The process as set forth in claim 6, wherein the transition metal is Fe, Co, or Ni.

13. The process as set forth in claim 6, wherein the oxide of the transition metal is Fe₃O₄.

14. The process as set forth in claim 13, wherein Fe₃O₄ particulates constituting the catalyst particles are secondary particles not less than 30 nm but not more than 300 nm in particle size, constituted by primary particles not less than 8 nm but not more than 15 nm in particle diameter.

15. Catalyst particles for producing a carbon nanocoil, the catalyst particles being produced by a process as set forth in claim 6.
